(19) United States
(12) Patent Application Publication
(10) Pub. No.: US 2009/0006727 A1
(43) Pub. Date: Jan. 1, 2009

(54) SYSTEM PROGRAMMING PROCESS FOR AT LEAST ONE NON-VOLATILE MEANS OF STORAGE OF A WIRELESS COMMUNICATION DEVICE, CORRESPONDING PROGRAMMING EQUIPMENT AND PACKET TO BE DOWNLOADED

(75) Inventor: Karim Odira, Issy-Les-Moulineaux Cedex (FR)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: WAVECOM, Issy-Les-Moulineaux Cedex (FR)

(21) Appl. No.: 12/163,267

(22) Filed: Jun. 27, 2008

(30) Foreign Application Priority Data
Jun. 28, 2007 (FR) 07/56131

(51) Int. Cl. G06F 12/02; G06F 12/00

(52) U.S. Cl. 711/103; 707/205; 711/E12.008; 707/E17.01

(57) ABSTRACT

It is proposed an in-system programming process, by programming equipment of at least one non-volatile storage memory of a communication device. The process includes the following steps: transmission, by the programming equipment to the communication device, of at least one extension file; transmission, by at least one of the extension files, called an enlightening extension file, of at least one first item of configuration information for the communication device; selection, by the programming equipment depending on the first item(s) of configuration information for the communication device of at least one data file associated to an internal application of the communication device; and transmission, by the programming equipment to the storage memory, of the selected data file(s).

### CROSS-REFERENCE TO RELATED APPLICATIONS

None.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of the production of a communication device (for example when making radio-communication terminals), and more precisely but not exclusively, the programming (installation of at least one software program and configuration of said at least one software program) of the non-volatile memory of wireless communication devices.

The non-volatile memory of a wireless communication device in general contains basic software (or internal software) which pilots the device as well as data for configuring the hardware or specific to functions requested by the customer.

### BACKGROUND OF THE DISCLOSURE

As part of the production of a communication device, it is necessary to program the non-volatile memory/memories (such as the EEPROM “Electrically Erasable and Programmable Read Only Memory” or the FLASH memory) present in this device.

To do so, there are two main techniques.

A first technique consists in using non-volatile memories that are pre-programmed by the memory manufacturer. In this case, the memory programming phase is not carried out during the production of the device but when the memories are produced using a file transmitted to the memory manufacturer.

Consequently, this first technique allows time to be saved when producing the device, but has the major disadvantage that the memories cannot be configured when the device is produced, which is a problem simply in that for example, a unique IMEI number cannot be entered into the device in production. The internal software therefore needs to include sub-software to configure the memories during production. Such configuration software comprises a code that can take up considerable space in the memory and that is only used for a few minutes (the configuration) in the life of the product: after this, it is a “dead code”, useless for the nominal operation of the product.

A second technique for programming non-volatile memories consists in the in-system programming of these memories, wherein the content of the memories is installed by downloading, via a communication link (for example a JTAG link), into the device via download software on the production rig after the memories have been physically integrated into the device. The configuration of the content of the memories is carried out after downloading.

Apart from the file containing the internal software of the device, it is often necessary to download other data files, especially files to configure the device: information of the software version, sets of display fonts, messages and other resources specific to a language (also called language packs), data that is specific to functions that are to be used on the device, etc. For a given software version, the large number of possible configurations may mean that a large number of downloadable files need to be created.

Consequently, according to a first solution, the download software downloads a global packet to be downloaded comprising all of the files corresponding to all of the possible configurations of the device (and especially the different versions of the internal software to be installed on the device).

The configuration of the internal software of the device is carried out after downloading either from the production rig via a JTAG link for example, or automatically internally within the device (which implies that the global packet must further comprise a special data structure which describes for each file the conditions required for the installation of the file, as well as any operations that are required before or after the installation of this file).

However, this global packet is very large and takes up a lot of memory space in the device, and it is long and complex to download.

According to a second solution, the download software is parametered to send the device a minimum packet only comprising the files required for the configuration of the internal software as required by the customer and suited to the hardware.

Consequently, a minimum packet is a combination of files further comprising the internal software, software configuration files and data to activate the paying functions (for example the use of the GPRS class 10 protocol, the real time extensions of the registered trademark Open AT environment, etc.).

In this way, in order to be able to make the minimum packets especially adapted to all of the possible internal software versions, to all of the possible customer orders, to all possible hardware versions, the operator of the production rig therefore has to process an enormous quantity of files. The author of the internal software or the developer of the production rig must in particular prepare several dozen different files, with each new software version supplied. Furthermore, the software piloting the production rig must be regularly adapted to take into account the appearance of new files, changes in name and the precise combination to be downloaded to obtain the configuration requested by the customer.

This process has become so complex that few people know how to draw up the precise list of files to be downloaded, the problem has become especially acute with the introduction of the wireless microprocessor (registered trademark) as henceforth the manufacturing process has to be transmitted to the customers.

### SUMMARY

In compliance with one specific embodiment, the disclosure relates to an in-system programming process for at least one non-volatile storage means of a communication device.

According to an aspect of the disclosure, the programming process is remarkable in that it comprises the following steps:
transmission, by the programming equipment to the communication device, of at least one extension file;
transmission, by at least one of the extension files, called the enlightening extension file, of at least one first item of configuration information of the communication device;
selection, by the programming equipment depending on the first item(s) of configuration information for the communication device of at least one data file associated to an internal application of the communication device;
transmission, by the programming equipment to the storage means, of the selected data file(s),

wherein each extension file is a library of at least one function that can be relocated whose download address is obtained by means of at least one relocating instruction.

The general principle of this aspect of the disclosure is based on an “agile” programming process, which carries out a certain number of inspection operations with the aid of at least one extension file which returns information (for example the presence or absence of a given piece of hardware, a given type of memory or software already installed), then which transmits the extensions required for the storage to one or another storage means (whether this is a non-volatile memory or a software interface saving to a more complex file system) and finally which transmits the data files.

In this way, thanks to the above-mentioned inspection operations, a programming technique is obtained which permits only the required files to be downloaded to the non-volatile storage means and that is also simpler to use than the classic solution, notably due to the fact that the operator of the programming equipment (for example the production rig) no longer needs to manage large quantities of files.

Furthermore, this technique permits the quantity of data to be downloaded to the communication device to be reduced (as only the required files are downloaded) and flexibility to be introduced into the programming process in particular due to the interactions between the production rig and the communication device.

Finally, thanks to this type of extension file, it is possible to create an efficient dynamic link function (between an application for piloting the program installed on the communication device and the extension files), whether the communication device has a paged memory management or not and without recourse to a developed operating system.

Preferably, at least two extension files are transmitted during the transmission step, by the programming equipment to the communication device, of at least one extension file, wherein said at least two extension files interact via at least one bridge.

Consequently, even though the extension files are relocatable library functions, they can communicate with one another via the bridges.

According to one example, the programming process further comprises a compression step for the selected data file(s) used by the programming equipment before it/they is/are transmitted to the non-volatile storage means.

Consequently, bandwidth may be economised when transmitting the selected data file(s).

Preferably, at least one of the transmissions uses at least one of the serial communication protocols belonging to the group comprising:
the RS232 protocol;
the USB protocol.

Advantageously, the programming process further comprises a reception step by the programming equipment of at least a second item of configuration information for the communication device and said selection step takes account of said second item of configuration information for the communication device.

For example, the second item of configuration information for the communication device is a customer order.

In one embodiment in compliance with an aspect of the disclosure, the programming equipment interprets at least one programming scenario for the communication device, wherein said scenario comprises at least said transmission and selection steps.

Preferably, the programming equipment comprises a first application for piloting the programming in the programming equipment and the programming process comprises a transmission step, by the programming equipment to the communication device, of at least one second application for piloting the programming in the communication device.

Advantageously, the programming equipment carries out at least one remote command available in the communication device.

This remote command may be especially available in an application for piloting the programming installed on the communication device or even in an extension file previously installed on the communication device.

An aspect of the disclosure also relates to a computer program product that may be downloaded from a communication network and/or saved onto a support that may be read by a computer and/or run by a processor, characterised in that it comprises program code instructions to run the programming process steps as previously described, when said program is run on a computer.

Another aspect of the disclosure relates to a means of storage, that may be partially or totally removable and that can be read by a computer, which stores a set of instructions that may be run by said computer to install the programming process as previously described.

Another aspect of the disclosure relates to in-system programming equipment of a least one non-volatile means of storage of a communication device.

According to aspect of the disclosure, the programming equipment comprises:
means of transmitting, to the communication device, at least one extension file;
means of receiving, from at least one of the extension files, called the enlightening extension file, at least one first item of configuration information for the communication device;
means of selecting, depending on the first item(s) of configuration information for the communication device, of at least one data file associated to an internal application of the communication device;
means of transmitting, to the storage means, the selected data file(s).

Another aspect of the disclosure relates to a packet to be downloaded comprising at least one extension file, at least one data file associated to an internal application of the communication device and at least one programming scenario for the communication device, wherein said scenario comprises at least the programming process steps as previously described.

The advantages of the computer program product, means of storage, programming equipment and packet to be downloaded are the same as those of the above-mentioned programming process, and consequently are not described in more detail.

### BRIEF DESCRIPTION OF THE DRAWINGS

Other characteristics and advantages of an aspect of the disclosure will become clearer upon reading the following description, provided simply by way of illustration and which is in no way restrictive, and the appended drawings, among which:

FIG. 1 shows a diagram illustrating the programming by a production rig of a flash memory of a wireless microprocessor according to a specific aspect of the disclosure;

FIG. 2 shows the main steps of a programming process for the wireless microprocessor of FIG. 1 according to the above-mentioned specific aspect of the disclosure;

FIG. 3 presents an example according to the invention of the interactions between a function x of an extension X which, when it is run, requires a function y of an extension Y;

FIG. 4 illustrates the interactions between an extension and the control file interpreted on the production rig according to one specific aspect of the disclosure.

### DETAILED DESCRIPTION OF ILLUSTRATIVE EMBODIMENTS

The following description relates to the context of the production of communication devices to make wireless communication terminals.

In the following description, within the scope of this production, the programming process, by programming equipment (which, for example, is a production rig, for example in the form of an industrial type PC equipped with serial ports), of non-volatile storage means, which, for example, is a Flash memory, part of a wireless microprocessor (communication device) according to one specific embodiment of the programming process of the disclosure. Of course, according to one specific variant of this embodiment, the Flash memory is not integrated into the microprocessor but is simply connected to the microprocessor.

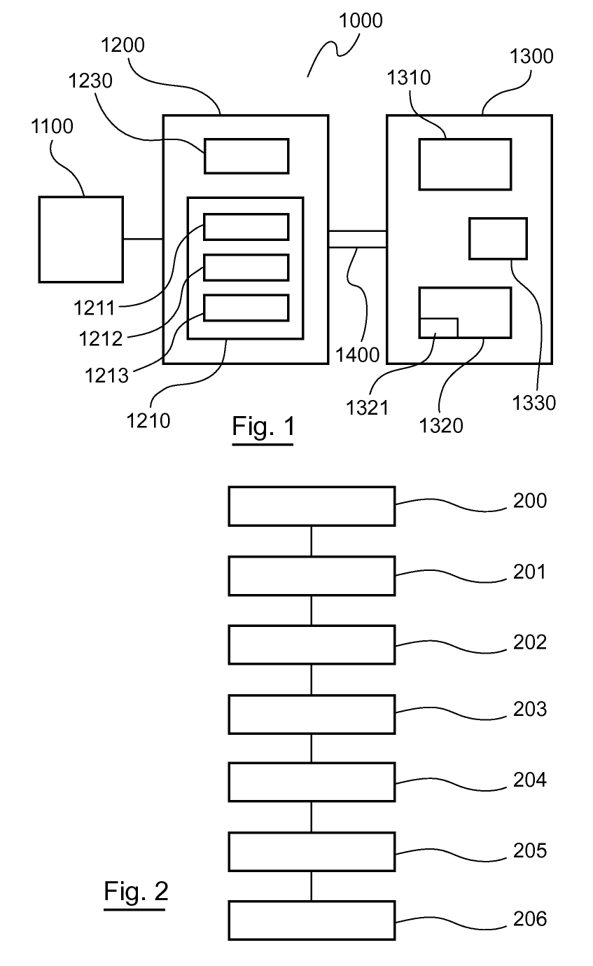

In relation to FIG. 1, below is an item of programming equipment 1000 of the Flash memory 1310 of the wireless microprocessor 1300 according to the above-mentioned specific embodiment of the disclosure.

The microprocessor 1300 also comprises a RAM memory 1320.

The programming equipment notably comprises:
the programming rig 1200 which is piloted by a first programming piloting application 1230 of the production rig (hereafter called first piloting application);
a second programming piloting application 1330 of the microprocessor 1300 (hereafter called second piloting application);

The production rig 1200 and the wireless microprocessor 1300 are connected by a bi-directional connection 1400, which is for example a link complying with a RS232 or USB type serial protocol (hereafter called the serial port).

Preferably, the first piloting application 1230 is commanded by a production operator via a man-machine interface 1100. However, in one variant of this specific embodiment, the production rig is an automatic production rig wherein the first piloting application is not commanded by an operator.

The production rig 1200 comprises an intelligent packet to be downloaded 1210 (hereafter designated by PTI), which is for example a compressed archive file (in the same way as a ZIP format file), comprising for example:
data files 1212 to be downloaded into the microprocessor 1300. The data files comprise data files which make possible the installation of at least one internal software program of the microprocessor and data files for the configuration of the microprocessor 1300 (notably comprising information on the software version, information on the hardware configuration or data specific to functions that are to be implemented on the device);
a control file 1211 (or programming scenario) which orchestrates the programming and in particular the downloading;
one of more software extension files 1213 (notably comprising an enlightening extension file 1321 which allows at least one configuration of the microprocessor 1300 to be detected).

A software extension file (hereafter designated by extension) is a file included in the PTI 1210 and which must be downloaded into a memory of the communication device 1300 to install new functions therein. An extension is not an application as such, as it does not run autonomously: it is more a set of routines designed to be run either directly b the kernel 1330, or by calls made from the control file 1211 of the PTI 1210, or from another extension.

These extensions 1213 permit the entire downloading process to be broken down into very modular entities installed according to the path defined by the author of the control file 1211 of the PTI 1210.

The first piloting application 1230 loads the PTI, runs (or more precisely interprets) its control file and sends the adequate data to the wireless microprocessor 1300 which stores it in non-volatile memory.

Consequently, the programming equipment uses programming software (also called downloading software) which comprises the first piloting application 1230 (which is for example a WIN32 type application) and the second piloting application 1330 (which is for example a kernel of the programming software). In this way, the programming software has a dual structure.

The first piloting application is run on the production rig 1200. This application communicates with the internal code of a processor of the base band of the microprocessor 1300. The kernel is therefore run by the ARM core of the microprocessor 1300.

This dual structure is found in all of the downloading software programs for mobile devices by serial connection, however within the scope of this specific embodiment of the disclosure, the specific feature is to have on the ARM core, no longer a complete, fixed application but a kernel 1330.

The kernel 1330 further comprises the basic functions required for the downloading, such as the management of the serial connection 1400. The kernel 1330 is open and can be dynamically linked to “plug-ins” 1213. In this way, each of the plug-ins may use these basic functions offered by the kernel.

FIG. 2 presents the main steps of a programming process of the wireless microprocessor of FIG. 1 according to the above-mentioned specific embodiment.

In one step 200, the first piloting application 1230 of the production rig 1200 loads the PTI 1210 and begins to interpret the control file 1211 (the steps described hereinafter result from the interpretation of the control file 1211).

In one step 201, the first piloting application 1230 of the production rig 1200 transmits, to the microprocessor 1300, downloading via the serial connection 1400, the kernel 1330 (second piloting application) so that it installs it therein.

Then, in step 202, the first piloting application 1230 of the production rig 1200 transmits, to the microprocessor 1300, downloading via the serial connection 1400, a set of extensions comprising the enlightening extension 1321 which permits at least one configuration of the microprocessor 1300 to be detected. Next, each of these extensions are installed in the microprocessor 1300 by the kernel 1330 (in particular, the enlightening extension 1321 is installed by the kernel 1330 in the RAM memory 1320).

In a step 203, the enlightening extension 1321 transmits, to the first piloting application 1230 via the serial connection 1400, at least one first item of information for the configuration of the microprocessor 1300 (for example a serial number, or any other information concerning the characteristics of the microprocessor 1300).

Next, in a step 204, the first piloting application receives, from the man-machine interface 1100 piloted by the production operator, at least one second item of information for the configuration of the microprocessor related to an order made by an acquirer (or customer) of the microprocessor one it has been produced.

Next, in a step 205, the first piloting application 1230 makes a selection from the data files 1212 according to the information for the configuration of the microprocessor 1300 previously received.

In a step 206, the first piloting application 1230 transmits to the microprocessor 1300 by downloading via the serial connection 1400, the selected data files, then these data files are recovered and decoded if required by the kernel 1330, which stores them, particularly in the flash memory 1310.

In this way, the first piloting application 1230 orchestrates the downloading using the control file 1211 which is a script whose interpretation leads to the sending of a least one data file 1212 to the microprocessor 1300, the installation of an extension in the microprocessor 1300 or the running of a remote command available in the kernel 1300 or in an extension that is already installed. These remote commands also permit data to be retransmitted from the microprocessor 1300 to the first piloting application 1230.

It is therefore possible to define an “agile” downloading process, carrying out a certain number of inspection operations with the aid of extensions 1213 which return information (for example the presence or absence of a given piece of hardware, a give type of memory or software already installed), then which transmits the extensions required for the storage to one or another storage support (whether this is a non-volatile memory or a software interface saving to a more complex file system) and finally which transmits the data files themselves, taken from the content of the PTI.

Preferably, the data transmitted will be further compressed to economise band width and decompressed by the kernel 1330 when received.

The process may still be configured from the first piloting application side 1230 with the use of parameters that can be used by the control file 1211 and which are defined by the first piloting application 1230 (and/or, as applicable, by the production operator via the man-machine interface 1100, wherein this interface can be modified by the instructions from the control file 1211, which permits an interactive downloading process to be obtained to limit the human operator errors (using confirmation requests for example).

The description of the customer order is sent to the first piloting application 1230 by means of these parameters, wherein the control file 1211 then installs an extension that is capable of decoding this parameter and to write it in configuration data form in non-volatile memory, wherein the control file 1211 finally remotely runs a procedure that is thus installed by transmitting the description provided by the production rig 1200. This step replaces the dozens of files that were required by a portable operation whose input parameter does not depend on the microprocessor 1300 and is the same as that found on the order form received at the production site.

The Extensions

An extension may be dedicated to managing a given peripheral device or to providing a function that is heavily dependent on the microprocessor 1300 (or more generally on the communication device to be programmed); two extensions may be, for this purpose, incompatible with one another, and therefore may not be downloaded together to the microprocessor 1300. Furthermore, the sending, by the first piloting application as part of the interpretation of the control file 1211, of these extensions may depend, for example, due to conditional clauses defined by the author of this control file 1211, on information from the kernel 1330 or extensions 1213 that have been previously downloaded.

It may therefore be impossible to identify a priori the nature and order of the extensions 1213 to be downloaded to the microprocessor 1300. This is why it is for example not possible to group/merge all of these extensions 1213 to simplify the downloading.

According to a classic solution to overcome this difficulty, the extensions are designed like dynamically-shared library functions. This involves dynamically loading, which is to say when the application is running, a set of routines that may be used by different library functions.

This imposes several constraints in the design of the functions which make up the library: some of them are overcome by the compilation tools, while others are usually overcome by the operating system. It is indeed the operating system which integrates the library into the “ecosystem” of the routines that are running. This phase is carried out transparently by developed operating systems which use processors equipped with paged memory management units (PMMU) such as the Linux (registered trademark) or Windows CE (registered trademark) operating systems.

Within the scope of this specific embodiment of the disclosure, the downloading software, designed to occupy as few resources as possible, cannot carry such developed operating systems. Furthermore, the microprocessor 1300 does not have such paged memory management units.

Consequently, within the scope of the disclosure, the dynamic link function (between the kernel and the extensions) is implemented efficiently so that it may be used in the kernel 1330, whether the microprocessor 1300 has a paged memory management unit or not, without the need for a developed operating system.

According to this specific embodiment of the disclosure, extensions are integrated into the memory of the microprocessor 1300 solely based on the information provided by the compilation and application construction tools used, for example, the “ARM Developer suite 1.2”, registered trademark, sold by ARM Ltd, registered trademark.

More precisely, it is easy with this software suite to produce relocatable code, which is to say that may be installed anywhere in memory, but at the cost of the annoying restrictions as concerns the initialising and use of memory pointers in C language. As explained in “What does “Error: L6248E: cannot have address type relocation” mean” (can be found at the address http://www.arm.com/support/faqdev/1240.html) among these annoying restrictions related to the relocation code we can mention for example the implementation of “finished condition machines”, that use a previously completed table associating each one of these conditions to procedures managing the transitions from or to this condition. This type of implantation is not possible with these restrictions.

More generally, it is impossible to re-use code that has been developed for other requirements, to create an extension without possibly having to make major transformations.

In return, it is more difficult to interact with the library routines used by the relocatable data (data that may be positioned at a random memory address);

In this specific embodiment of the disclosure, the extensions are created from a relocatable code. In this way, each extension is a library of at least one relocatable function whose code may be installed anywhere at all in the RAM memory and may be used again by the kernel 1330 as well as by other extensions.

This relocatable code and data are then combined with relocation instructions (created during a link resolution phase). The tools used create these relocation instructions (the notion of relocation instructions is explained in the article dated 23 Jan. 2007: “ELF for the ARM architecture”, with the reference GENC-003538v1.04 (current in ABI r2.05) by Richard EARNSHAW and available at the following address http://www.arm.com/pdfs/aaelf.pdf) for the ARM architecture according to a convention that is now obsolete, but which allows the above-mentioned of restrictions of the relocation code to be overcome. When integrating the extension, these relocation instructions are interpreted to modify the code and the data so as to “install” this extension in its loading address.

The first piloting application 1230 thus has the possibility of instructing the kernel 1330 to download to a new type of non-volatile memory or to a new complex data structure. It may also use an extension to obtain information from the device that cannot be obtained without having it run the code.

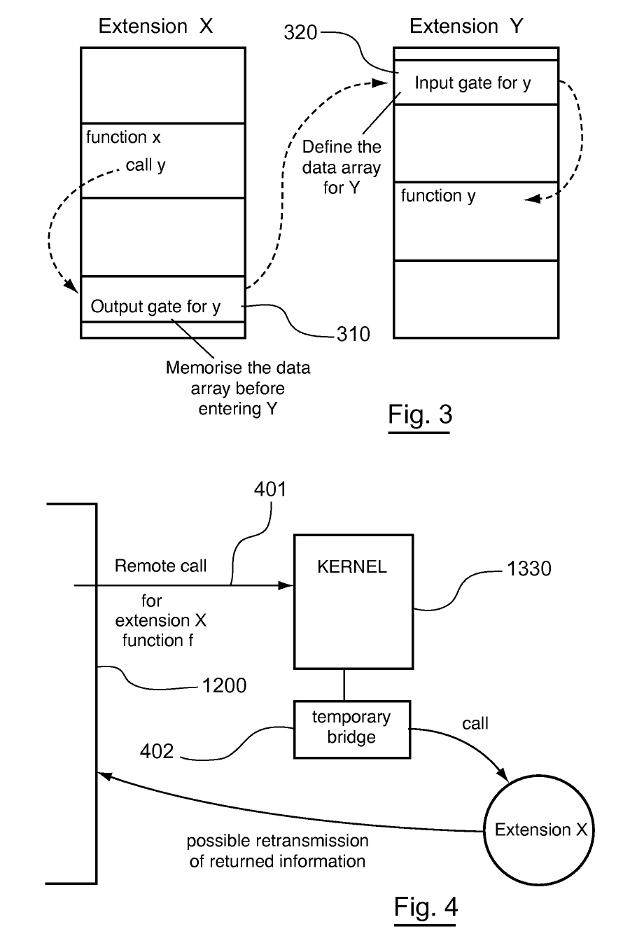

As concerns the problems of the interactions between the various libraries, as illustrated in FIG. 3 (which presents an example according to the disclosure of interactions between a function x of an extension X which, when it is run, requires a function y of an extension Y and which therefore, when run, calls this function y), they are resolved by the installation of an output ate for y 310 which memorises the data array before entering the Y extension and an input gate for y 320 which defines the data array of the extension Y. Consequently this makes the calls between libraries transparent by inserting the instructions required to change the data array used.

Finally, in one specific embodiment of the disclosure, the interactions between an extension and the control file 1211 interpreted on the production rig 1200 depend on a function of the kernel 1330.

In fact, as illustrated by FIG. 4, as part of such an interaction, the kernel 1330 receives a request 401 calling a function f of an extension X from the production rig 1200. Then the kernel 1330 tries to search for the extension X and the function f in the extension X called in this request. The kernel 1330 then creates a temporary gate 402 to the extension X designed to call this function f and connect to it via the temporary gate. The kernel then recovers the information sent by the production rig addressed to the function f of extension X.

The function f in the extension X may return to the production rig 1200 information which may for example be considered as the value returned by the function that has been remotely run by the control file 1211.

An aspect of the disclosure in particular is to overcome the disadvantages of the prior art.

More precisely, at least one aspect of the disclosure provides an in-system programming technique for at least one non-volatile storage means of a communication device, which only allows the required files to be downloaded into the non-volatile storage means and which is simpler than the existing solutions.

More precisely, at least one aspect of the disclosure provides such a technique that no longer requires the operator of the programming equipment (for example the production rig) to manage large quantities of files.

At least one other aspect of the disclosure uses such a technique, which permits the quantity of data to be downloaded into the device to be reduced.

The disclosure, in at least one of aspect, has another purpose of providing such a technique, which permits flexibility to be introduced into the programming process.

Although the present disclosure has been described with reference to one or more examples, workers skilled in the art will recognize that changes may be made in form and detail without departing from the scope of the disclosure and/or the appended claims.

1. In-system programming process, by programming equipment of at least one non-volatile storage memory of a communication device wherein the process comprises the following steps:
transmission, by the programming equipment to the communication device, of at least one extension file;
transmission, by at least one of the extension files, called an enlightening extension file, of at least one first item of configuration information for the communication device;
selection, by the programming equipment depending on the at least one first item of configuration information for the communication device of at least one data file associated to an internal application of the communication device; and
transmission, by the programming equipment to the storage memory, of the selected at least one data file,
wherein each extension file comprises a library of at least one function that can be relocated and whose download address is obtained by at least one relocating instruction.

2. The process of claim 1, wherein at least two extension files are transmitted during the transmission step by the programming equipment to the communication device, of at least one extension file, wherein said at least two extension files interact by a gate.

3. The process of claim 1, wherein the process further comprises compressing the selected at least one data file used by the programming equipment before transmission to the non-volatile storage memory.

4. The process of claim 1, wherein at least one of said transmissions uses at least one of the serial communication protocols belonging to the group comprising:
RS232 protocol;
USB protocol.

5. The process of claim 1, wherein the process further comprises a reception step by the programming equipment of at least a second item of information for the configuration of the communication device and wherein said selection step takes account of said second information for the configuration of the communication device.

6. The process of claim 1, wherein the programming equipment interprets at least one programming scenario for the communication device, wherein said scenario comprises at least the transmission and selection steps.

7. The process of claim 1, wherein the programming equipment comprises a first programming piloting application on the programming equipment and the process further comprises a transmission step, by the programming equipment to the communication device, of at least one second programming piloting application on the communication device.

8. The process of claim 1, wherein the programming equipment runs at least one remote command available in the communication device.

9. Computer-readable storage medium, storing a computer program comprising a set of instructions executable by a computer in order to implement a system programming process, by programming equipment of at least one non-volatile storage memory of a communication device comprising the following steps:
transmission, by the programming equipment to the communication device, of at least one extension file;
transmission, by at least one of the extension files, called an enlightening extension file, of at least one first item of configuration information for the communication device;
selection, by the programming equipment depending on at least one first item(s) of configuration information for the communication device of at least one data file associated to an internal application of the communication device; and
transmission, by the programming equipment to the storage memory, of the selected at least one data file,
wherein each extension file comprises a library of at least one function that can be relocated and whose download address is obtained by at least one relocating instruction.

10. In-system programming equipment comprised of at least one non-volatile storage memory of a communication device, wherein the programming equipment comprises:
means of transmitting, to the communication device, at least one extension file;
means of receiving, from at least one of the extension files, called an enlightening extension file, at least one first item of configuration information for the communication device;
means of selecting, depending on the at least one first item of configuration information for the communication device, of at least one data file associated to an internal application of the communication device; and
means of transmitting, to the storage memory, the selected at least one data file.

11. A packet stored on a computer-readable medium and to be downloaded, the packet comprising at least one extension file, at least one data file associated to an internal application of the communication device and at least one programming scenario for the communication device, wherein said scenario comprises at least the programming process steps comprising:
transmission, by programming equipment to the communication device, of the at least one extension file;
transmission, by at least one of the extension files, called an enlightening extension file, of at least one first item of configuration information for the communication device;
selection, by the programming equipment depending on the at least one first item of configuration information for the communication device of at least one data file associated to an internal application of the communication device; and
transmission, by the programming equipment to the storage memory, of the selected at least one data file,
wherein each extension file comprises a library of at least one function that can be relocated and whose download address is obtained by at least one relocating instruction.
